(19) United States
(12) Patent Application Publication
(10) Pub. No.: US 2006/0255511 A1
(43) Pub. Date: Nov. 16, 2006

(54) X-ray detection of the presence and/or condition of polymer components

(76) Inventors: Benjamin G. Hardy, Elkhorn, WI (US); Curt Hagen, Delavan, WI (US); Gary Ferguson, Milton, WI (US); Drew J. Van Norman, Whitewater, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/240,646

(22) Filed: Oct. 3, 2005

Related U.S. Application Data
(63) Continuation-in-part of application No. 11/128,398, filed on May 13, 2005.

(51) Int. Cl. G01B 15/00

(52) U.S. Cl. 264/406; 264/488

(57) ABSTRACT

A method for evaluating a polymer component comprises adding a radiopaque material to a polymer material to form a combined material having radiopaque properties, manufacturing the item at least partial out of the combined material, applying x-rays to the item, and viewing an x-ray image of the item to detect the structural condition of the item.

### CROSS-REFERENCE TO RELATED APPLICATIONS

This application claims priority to and is a continuation-in-part of U.S. patent application entitled, X-RAY DETECTION OF POLYMER COMPONENTS IN MATERIAL PROCESSING, filed May 13, 2005, having a Ser. No. 11/128,398, the disclosure of which is hereby incorporated by reference in its entirety.

### FIELD OF THE INVENTION

The present invention relates generally to detection of material processing equipment components in processed materials. More particularly, the present invention relates to detection of polymer material processing components and pieces thereof, in materials such as for example food.

### BACKGROUND OF THE INVENTION

Material processing equipment is in wide use to manufacture a variety of materials and finished products, including for example food products. Some types of such equipment include mixing, pumping and heat transfer devices. One example of such a device is a scraped surface heat exchanger, which has an elongated tube surrounding a central drive shaft. The drive shaft supports radially extending paddles or blades that rotate with the shaft inside the tube. The food material is forced through the tube and is mixed by the paddles, while also changing temperature due to heat or cooling effects provided by the tube. The paddles contact and scrape the inside of the tube as the shaft rotates. Scraped surface heat exchangers also often feature various bearings to support the rotating drive shaft and associated seals provide material sealing.

In the above example, the blades and bearing components have sometimes been made of a metal material. The use of metal materials provides durability, but also has some disadvantages. For example, metal blades tend to wear the inside of the heat exchanger tube due to the relative hardness of the blades relative to the inside surface of the tube. This is undesirable in part because the tube is a major component of the system, while the blades can be relatively easy and inexpensive to replace.

To alleviate this problem, and for other reasons, scraped surface heat exchangers and other food processing devices have replaced many formerly metal components with polymer ones. For example, many scraped surface heat exchangers today use polymer scraper blades, which can economically be formed into special shapes, do not tend to wear the inside of the tube, and which are easily replaced. Thus polymer blades can extend the life of the overall device by extending the life of the tube, which as noted above is a major component. Bearing components have also been implemented in polymer, providing various benefits. Polymer blades, bearings and seals have been developed which meet regulatory requirements. Such blades, bearings and seals are often made of PEEK, PTFE, or polyethylene.

Another concern in the use of food processing devices, such as for example scraped surface heat exchangers, is the purity of contents of the finished foods. Due to increased safety and quality concerns, many food processors are using and seeking out non-destructive testing equipment to monitor the contents of finished and even packaged food products. The food product may be tested at some stage in the overall processing, or even after packaging has occurred. In either case, the processor is viewing the product to ensure that no foreign bodies are present.

The desired result is to be able to detect and then quarantine any food product having undesirable foreign bodies, such as for example processing machinery parts, so it is not delivered to consumers in this condition. Common foreign bodies that may occur include seal parts, nuts, bolts, kettle filings and shavings, miscellaneous metal parts, rubber gaskets, and catastrophically failed scraped surface heat exchanger blades. The testing may be done while the product is in its packaging, which may be, for example, polymer, metal or some combination of these. In general, many food processors particularly prefer to test the final package product, as opposed to the product directly before packaging, because foreign bodies can enter the product even in its final packaging stage.

The two most prevalent testing methods are metal detectors and x-ray detectors. Metal detectors have two major drawbacks with respect to items such as scraped surface heat exchanger blades. While metal detection is suitable for metal blades, in recent times many processors have moved to polymer scraper blades as described above to increase the life of their devices. One way to make polymer blades detectable using conventional metal detection testing equipment is to incorporate a metal additive, typically powdered or particulate stainless steel, into the polymer material. This additive can cause accelerated tube wear compared to a purely polymer blade, which counteracts to some extent the benefit of the polymer blade. Metal detection also has the disadvantage that canned packaged food cannot be metal detected in its final form, because the can itself sets off the machine.

The second testing method, x-ray detection, is becoming more popular, for example because of its utility with metal cans. However, such a x-ray method does not usually detect polymer pieces such as failed polymer blades, seals, or bearings. That is because the conventionally used x-ray devices do not show a significant difference between the polymer contaminant piece and the food.

Accordingly there is a need in the art for an improved testing system and method, and corresponding components, that can provide detection of polymer contaminant parts in processed materials such as food products, including finished packaged materials such as foods.

In another area where x-rays have been used with respect to metallic objects is in the area of metal casing, forgings, and large metal vessels such as pressure vessels. X-ray has long been used to check these components for cracks or other defects since these components historically were metallic. However, such components are more frequently being made of plastics. In some instances plastics can provide lighter weight, easier shape forming, and/or easier recycling, among other benefits. However, x-ray evaluation does not work for plastics in the way it works for metals.

Plastic materials are also coming under greater use in the law enforcement, military, and safety areas. In particular, various weapons including guns and knives and associated parts, mines, grenades, body armor and certain other controlled or dangerous items often include plastic components. Since these items historically had previously been made of metal, in many instances x-ray detection has been used to detect their presence. For example, a well known method of detection of knives and guns has historically been having persons walk through a metal detector. Such conventional metal detectors may not detect plastics. Another method of detecting these dangerous or controlled articles has been the use of x-rays, such as the x-raying of passenger luggage. Such x-ray devices may show plastic items at least to some extent, however they may not show up as clearly as metal items.

Another disadvantage associated with the metal detection of objects on persons, is that many persons have medical implants that are made of metal which will be detected by the metal detector, that provide a false alarm. Persons may need to carry special identification that has these medical implants. Currently, more and more medical implants are being made of plastic. This has the advantage that they do not set off metal detectors. However, in the medical field they may not be highly observable by the x-ray process. This could hinder diagnosis of medical conditions or monitoring of the conditions of the implants. Therefore, it would be desirable to have medical implants that are visible under x-ray to a suitable degree.

Accordingly, there is a need in the art for an improved detection system and method that could detect plastic items using x-rays.

X-ray of a plastic component may not properly highlight cracks or defects in the component. Therefore, it will be desirable to have plastic items that are more suitable to x-ray evaluation.

### SUMMARY OF THE INVENTION

The present invention in some embodiments provides an improved testing system and method, that can provide detection of the presence and/or condition of polymer components.

In accordance with one embodiment of the present invention, a method for evaluating and/or detecting a polymer item, comprises adding a radiopaque material to a polymer material to form a combined material having radiopaque properties, manufacturing the item at least partially out of the combined material, applying x-rays to the item, and viewing an x-ray image of the item to detect the structural condition of the item.

In accordance with another embodiment of the present invention, a system for evaluating and/or detecting a polymer item, comprises a radiopaque material added to a polymer material to form a combined material having radiopaque properties, the item being manufactured at least partially out of the combined material, means for applying x-rays to the item, and means for viewing an x-ray image of the item to detect the structural condition of the item.

In accordance with yet another embodiment of the present invention, a manufactured item, comprises a first polymer material, and a second radiopaque material provided as an additive to the first polymer material.

In accordance with yet still another embodiment of the present invention, a manufactured item, comprises a polymer material, and a means for blocking x-ray transmission provided as an additive to the first polymer material.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a scraped surface heat exchanger blade according to one preferred embodiment of the invention.

FIG. 2 is a perspective view of a scraped surface heat exchanger blade according to another preferred embodiment.

FIG. 3 is a perspective view of a bearing according to another preferred embodiment.

FIG. 4 is a cross-sectional view of a pressure vessel according to another preferred embodiment.

FIG. 5 is a flow diagram of steps involved in another preferred embodiment.

### DETAILED DESCRIPTION

Some preferred embodiments of the invention can provide an improved testing system and method, and corresponding components, that can provide detection of polymer contaminant parts in processed materials such as products, including materials such as finished packaged foods. Exemplary preferred embodiments will now be described with reference to the drawing figures in which like elements refer to like parts throughout. This application uses the term polymer to include at least plastics and elastomers.

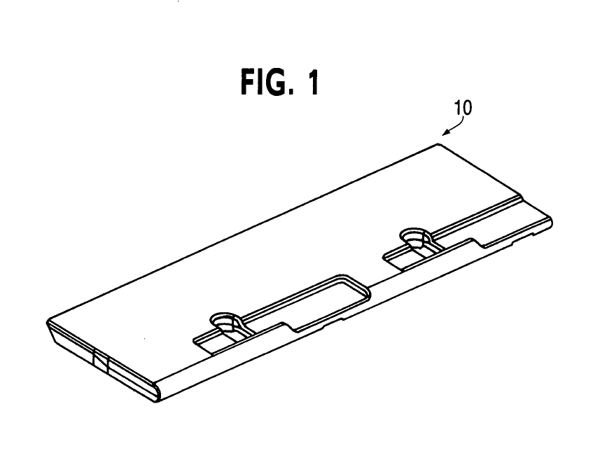

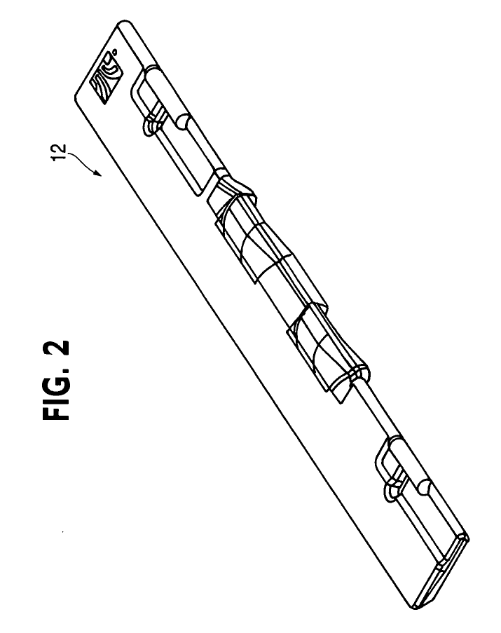

FIGS. 1 and 2 illustrate scraped surface heat exchanger blades designated 10 and 12 respectively. Blade 10 has a relatively simple flat configuration that can be formed by machining from flat polymer stock or by injection molding. Due to its more complex shape, blade 12 is preferably a molded item. Each blade is comprised of a polymer material having a radiopaque additive. The polymer blade composition material is preferably PEEK, but may also be any polymer, plastic or elastomer including by way of example PTFE or polyethylene.

Prior to molding (or other original manufacture process) the material has had added to it in particulate form a material that is radiopaque, that is a material that shows up or is visible or detected by x-ray detection devices. Non-metallic radiopaque materials are preferred due to their superior low wearing characteristic of the single blade tube. Preferred radiopaque materials include but are not limited to barium sulfate, bismuth oxide, and lead oxide. Lead oxide is an example of a material that may not be suitable for food applications but could be used in processing equipment for other non-food applications.

It will be appreciated that the preferred additive radiopaque materials are non-metallic. This is because metallic additives would be abrasive and cause wear of parts in frictional contact such as the tube wear problem described above. The preferred materials of barium sulfate, bismuth oxide, and lead oxide have the advantage that they cause less tube wear than would stainless steel or other similar metal additives.

The selected additive materials for addition to the polymer components do not need to be selected for any ability or lack thereof to appear in metal detection processes. Rather, the additive materials are selected based on their ability to show up on x-ray tests, and their compatibility with the polymer being used, as well as compatibility and wear characteristics imparted to the component such as a blade or bearing or seal.

Another advantage of for example barium sulfate is that it is already approved as an additive to polymer parts such as scraper blades, bearings, or seals as a colorant. This embodiment of the present invention takes advantage of the x-ray detection property of this and like materials in a way that is new, in effect taking an additive that is already approved as safe and using it in an x-ray detection system.

The selected additive material preferably has the property that the amounts of the additive that are present in normal microscopic wear particles are safe to consumers even as they enter the food. However, in the case of catastrophic failure of the part (such as a broken or chipped blade, bearing, or seal) the relatively large piece that breaks off can be detected in the food via x-ray testing.

Another advantage of the preferred embodiment is that since x-ray testing of food in general is already in use, a new and valuable benefit is provided that polymer parts such as blades, bearing and seals can be detected without needing additional complex testing systems. Moreover these embodiments allow non-metallic additives to be used and avoid the need for metallic additives which cause wear problems.

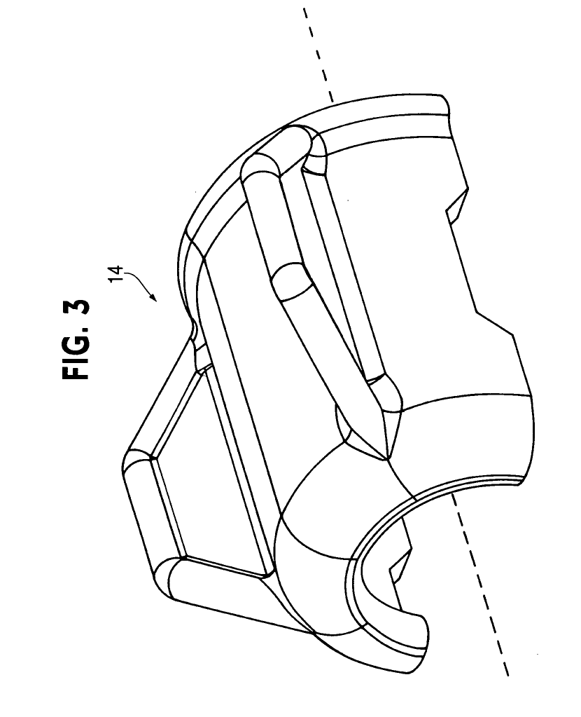

The preferred materials used in the invention can be applied to any polymer-based component of a material processing system. Thus, besides detection of broken components in foods, the invention can provide detection of broken components in other processed materials. Another example is a bearing for a scraped surface heat exchanger such as the illustrated bearing half 14 in FIG. 3. This bearing is made from the same material described above with respect to FIGS. 1 and 2, e.g. a polymer material having a non-metallic radiopaque additive.

Although barium sulfate, bismuth oxide, and lead oxide are described as preferred additives to the polymer, it will be appreciated that other embodiments of the invention may include other additives which will impart a radiopaque, that is x-ray detectible quality.

One method of forming the final part such as a blade or seal involves adding the radiopaque additive to the raw polymer prior to an injection molding or other molding process. In some preferred embodiments, for example, the part may be made from a composite involving 2%-5% barium sulfate added to a remainder of PEEK to make a scraper blade, bearing, or seal. Using this percentage ratio of barium sulfate results in a blade where the typical wear pattern does not result in harmful, or detectable, amounts of additive (in this example barium sulfate) into the food product due to normal wear. However, broken chips or parts of a size that would cause concern are detectable by current conventional x-ray systems.

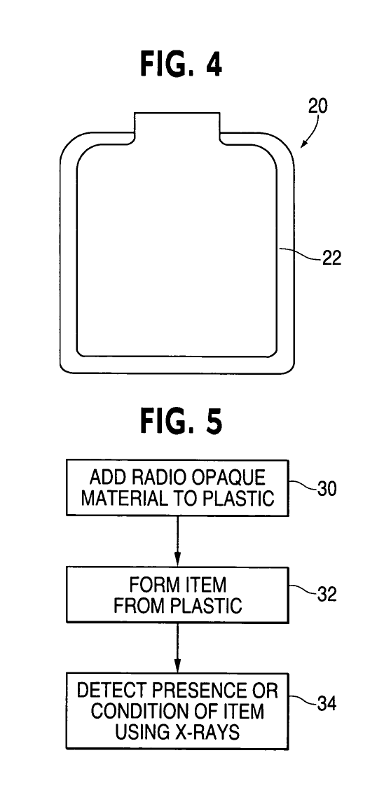

FIG. 4 is a cross-sectional view of a pressure vessel 20. The pressure vessel 20 is a molded from any of the polymers described above, with a radiopaque additive as such described above. In order to detect cracks or other structural failures in the pressure vessel, such as a crack 22, the pressure vessel 20 can be radiated with x-rays and the resulting image visualized on the display. The presence of radiopaque materials will cause the crack to appear in contrast to the other parts of the vessel.

While a pressure vessel 20 is shown, it will be appreciated that this technology would also be suitable for evaluating medial implants to check for cracks or other structural problems.

FIG. 5 provides a flow diagram of the steps described above. That is, at step 30 radiopaque materials is added to the polymer. The polymer and radiopaque material may be any of those described above. At step 32 an item is formed by the plastic typically by molding, but by any suitable process. The item may be a pressure vessel or any other item where it is desirable to evaluation its structural characteristics. At step 34 the item is radiated with x-rays and the resulting image is evaluated to detect the condition of the item.

In other embodiments, the radiopaque material may be added to different items where it is desired merely to detect the presence of the item and not to evaluate the item structurally as described above. For example, at step 34 the step may merely be carried out to detect the presence of an item. Items where it may be desirable simply to detect the presence can include weapons, mines, grenades, body armor or other controlled materials. If any of these items or material have a radiopaque material added to the polymer structure, then it becomes possible to conveniently detect them using x-rays. Thus, when luggage or baggage is being screened, sensitive items, that have been pretreated with the radiopaque material, will be more readily visible to the detection operator.

In the case of pressure vessels for example it will be possible to check for not only internal cracks but also voids or other failures that can occur in the thick sectioned plastic.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for evaluating and/or detecting a polymer item, comprising:
adding a radiopaque material to a polymer material to form a combined material having radiopaque properties;
manufacturing the item at least partially out of the combined material;
applying x-rays to the item; and
viewing an x-ray image of the item to detect the structural condition of the item.

2. The method of claim 1, wherein the evaluating step includes detecting crack and/or voids in the structure of the item.

3. The method of claim 1, wherein the item is a scraped surface heat exchanger component.

4. The method of claim 1, wherein the item is a pressure vessel.

5. The method of claim 1, wherein the item is a medical implant.

6. The method of claim 1, wherein the item is one of a weapon, security device or controlled device.

7. The method of claim 1, wherein the manufacturing step includes molding the item using a molding process.

8. The method of claim 1, wherein the polymer material is PEEK.

9. The method of claim 1, wherein the radiopaque material is selected from the group of barium sulfate, bismuth oxide, and lead oxide.

10. A system for evaluating and/or detecting a polymer item, comprising:
a radiopaque material added to a polymer material to form a combined material having radiopaque properties, the item being manufactured at least partially out of the combined material;
means for applying x-rays to the item; and
means for viewing an x-ray image of the item to detect the structural condition of the item.

11. The system of claim 10, wherein the item is a scraped surface heat exchanger component.

12. The system of claim 10, wherein the item is a pressure vessel.

13. The system of claim 10, wherein the item is a medical implant.

14. The system of claim 10, wherein the item is one of a weapon, security device or controlled device.

15. The system of claim 10, wherein the item is molded using a molding process.

16. The system of claim 10, wherein the polymer material is PEEK.

17. The system of claim 10, where the radiopaque material is selected from the group of barium sulfate, bismuth oxide, and lead oxide.

18. A manufactured item, comprising:
a first polymer material; and
a second radiopaque material provided as an additive to the first polymer material.

19. The item of claim 18, wherein the first material is PEEK.

20. The item of claim 18, where the second material is selected from the group of barium sulfate, bismuth oxide, and lead oxide.

21. A manufactured item, comprising:
a polymer material; and
a means for blocking x-ray transmission provided as an additive to the first polymer material.

22. The item of claim 21, wherein the polymer material is PEEK.

23. The item of claim 21, where the blocking means is selected from the group of barium sulfate, bismuth oxide, and lead oxide.
